(19) United States
(12) Patent Application Publication
(10) Pub. No.: US 2024/0221755 A1
(43) Pub. Date: Jul. 4, 2024

(54) Voice Assistant Controller

(71) Applicant: Spotify AB, Stockholm (SE)

(72) Inventors: Daniel BROMAND, Boston, MA (US); Björn Erik ROTH, Stockholm (SE)

(73) Assignee: Spotify AB, Stockholm (SE)

(21) Appl. No.: 18/090,105

(22) Filed: Dec. 28, 2022

(51) Int. Cl. G10L 15/32; G10L 15/22

(52) U.S. Cl. CPC G10L 15/32; G10L 15/22; G10L 2015/088; G10L 2015/223

(57) ABSTRACT

A method for managing voice assistants is disclosed. The method may be performed by a voice assistant controller communicatively coupled to a plurality of voice assistants. The voice assistant controller may determine a first order of the plurality of voice assistants. Based at least in part on the first order, the voice assistant controller may activate one or more voice assistants. Furthermore, the voice assistant controller may determine a second order of the plurality of voice assistants. Based at least in part on the second order, the voice assistant controller may suspend an active assistant, activate a suspended assistant, or perform both operations.

### BACKGROUND

A user may interact with a voice assistant by providing a voice input that includes a request. For example, the user may ask the voice assistant to play media content, message a friend, or schedule an appointment. The voice assistant may process the request and generate a response. However, one voice assistant may not have all the functionality desired by a user, so a user may interact with more than one voice assistant.

Various challenges arise when a user may interact with multiple voice assistants. One set of challenges relates to managing the voice assistants. For example, a voice-enabled device may have limited resources, and each voice assistant may consume resources. For example, a voice assistant may use computer memory, storage, processing power, and battery life. Furthermore, when a voice assistant is active, it may consume even more computer resources. As a result, it may be difficult to implement multiple voice assistants on a single device. Furthermore, even if multiple voice assistants are implemented on a device, it may, in some instances, be impracticable to have each of the voice assistants active at a time. Thus, the device may have to determine which of the voice assistants to activate. Furthermore, managing an addition, removal, or change of a voice assistant may be a challenge as the number of available voice assistants increases.

### SUMMARY

In general terms, this disclosure relates to a method and device for managing a plurality of voice assistants. In some examples, the device includes a voice assistant controller and a plurality of voice assistants. In some embodiments and by non-limiting example, the voice assistant controller may determine an order of the plurality of voice assistants and, based at least in part on the order, activate a certain number of them. In some embodiments, the voice assistant controller may detect an event and, in response to detecting the event, determine a second order of the voice assistants. Based on the second order, the voice assistant controller may suspend an active assistant, activate a suspended assistant, or perform both operations.

One aspect is a method for method for managing a plurality of voice assistants. The method comprises determining a first order of the plurality of voice assistants; based at least in part on the first order, activating one or more voice assistants of the plurality of voice assistants; determining a second order of the plurality of voice assistants; based at least in part on the second order, performing one or more of: suspending an active voice assistant of the one or more active voice assistants; or activating a suspended voice assistant of the plurality of voice assistants.

Another aspect is a device for processing voice input. The device comprises a plurality of voice assistants; a processor; and memory storing instructions that, when executed by the processor, cause the device to: determine a first order of the plurality of voice assistants; based at least in part on the first order, activate one or more voice assistants of the plurality of voice assistants; determine a second order of the plurality of voice assistants; based at least in part on the second order, perform one or more of: suspend an active voice assistant of the one or more active voice assistants; or activate a suspended voice assistant of the plurality of voice assistants.

A further aspect is a method for managing a plurality of voice assistants. The method comprises determining a first order of the plurality of voice assistants; based at least in part on the first order, grouping the plurality of voice assistants into an active group of voice assistants and a suspended group of voice assistants; activating each voice assistant of the active group of voice assistants; detecting an event; in response to detecting the event, determining a second order of the plurality of voice assistants; based at least in part on the second order, performing one or more of: suspending a voice assistant of the active group of voice assistants; or activating a voice assistant of the suspended group of voice assistants.

### BRIEF DESCRIPTION OF THE DRAWINGS

FIG. 1 illustrates example instances of a device in which aspects of the present disclosure may be implemented.

FIG. 2 illustrates a plurality of example orders of voice assistants.

FIG. 3 illustrates a plurality of example orders of voice assistants.

FIG. 4 illustrates a schematic block diagram of example aspects of a voice assistant controller.

FIG. 5 is a flowchart of an example method for performing aspects of the present disclosure.

FIG. 6 is a flowchart of an example method for performing aspects of the present disclosure.

FIG. 7 illustrates a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

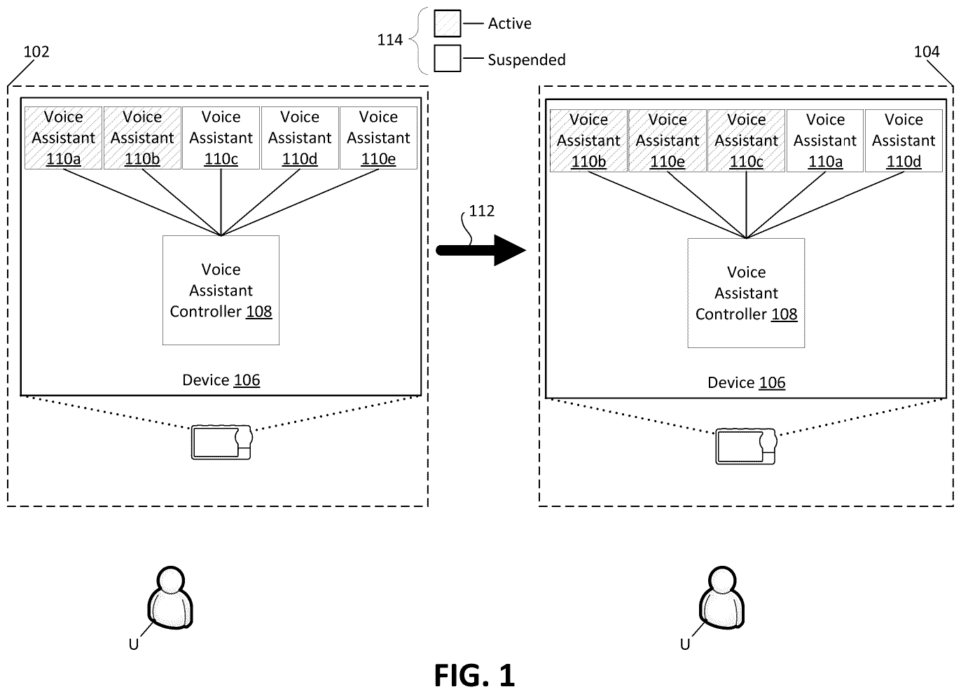

FIG. 1 illustrates instances 102-104 of a device 106. The instance 102 may correspond to the device 106 at a first time, and the instance 104 may correspond to the device 106 at a second time. In the example of FIG. 1, the device 106 includes a voice assistant controller 108 and a plurality of voice assistants 110a-e. As described below, the voice assistant controller 108 may detect the event 112 and, in response, take one or more actions related to the voice assistants 110a-e, thereby transitioning the device 106 from the instance 102 to the instance 104.

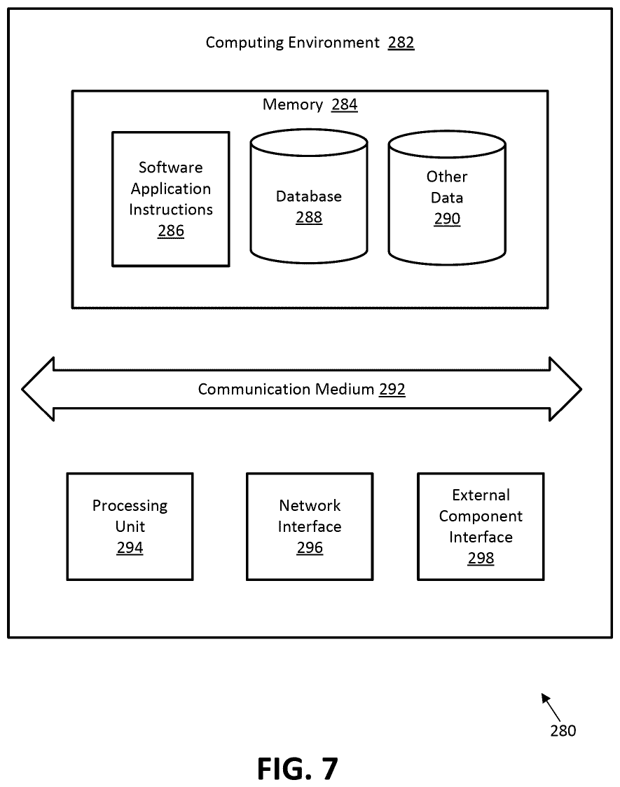

The device 106 may be a computing device including a processor, memory, input and output components, non-transitory computer-readable media, and other computer components. An example of a computer system in which aspects of the device 106 may be implemented is further described below in connection with FIG. 7. The device 106 may be a voice-enabled device. In some embodiments, the device 106 may be a mobile device, such as a mobile phone, tablet, or smart device. In some embodiments, the device 106 may be a smart speaker. In some embodiments, the device 106 may be an IoT device. In some embodiments, the device 106 may be a device that is integrated into another system, such as a device that is embedded into a digital dashboard or into a car system. The device 106 may include components for receiving, processing, and responding to a voice input. Furthermore, the device 106 may include components for managing voice assistants, such as the voice assistant controller 108, which may, among other things, manage which voice assistants are active.

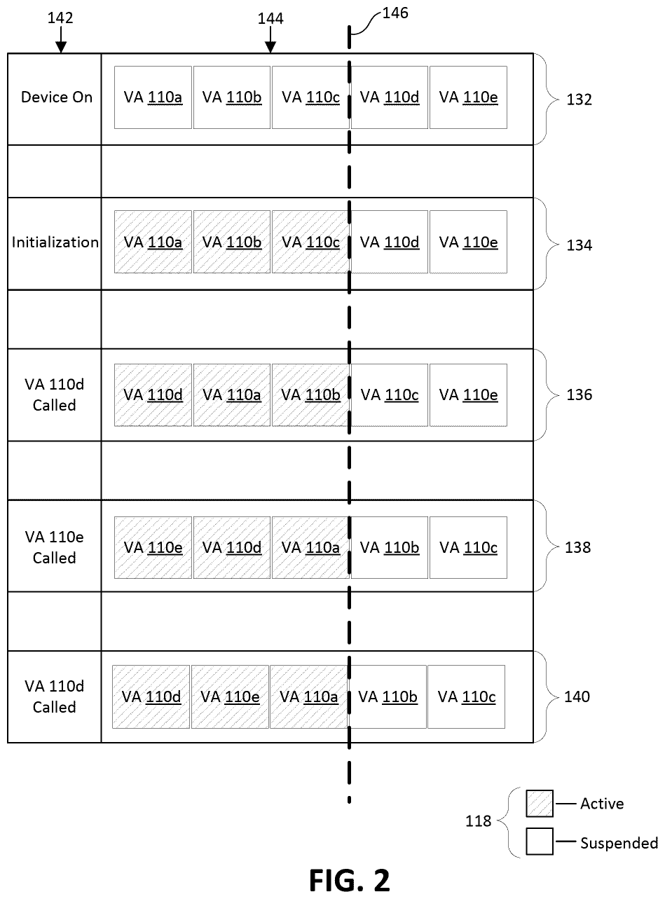

The voice assistant controller 108 may be installed, as shown in the example of FIG. 1, on the device 106. The voice assistant controller 108 may perform operations related to managing the plurality of voice assistants 110a-e. For example, the voice assistant controller 108 may perform operations related to activating or suspending voice assistants. In some embodiments, the voice assistant controller 108 may determine how many voice assistants are active, track which voice assistants are active, send activation instructions to a suspended voice assistant, and send deactivation instructions to an active voice assistant. Furthermore, in some embodiments, the voice assistant controller 108—or a system that the voice assistant controller 108 is a part of—may perform one or more operations related to processing utterances (e.g., voice input) from a user U. For example, the voice assistant controller 108 may receive an utterance from the user U, identify a voice assistant of the voice assistants 110a-e that is associated with the utterance, and communicate the utterance to the identified voice assistant. Aspects of the voice assistant controller 108 are further described below in connection with FIGS. 2-6. As shown, the voice assistant controller 108 may be communicatively coupled to each of the voice assistants 110a-e.

Each voice assistant of the voice assistants 110a-e may include a service that can receive and process a voice request. In some embodiments, the plurality of voice assistants 110a-e may be installed, as shown in the example of FIG. 1, on the device 106. In other embodiments, one or more of the voice assistants 110a-e, or one or more components of the voice assistants 110a-e, may be communicatively coupled with the device 106 but may not be installed on the device 106. In some embodiments, the voice assistants 110a-e may be separated into two groups: an active group and a suspended group (e.g., as illustrated by the key 114, which indicates that voice assistants including diagonal lines are active, whereas voice assistants without such lines are not active). In some embodiments, a voice assistant may be in a state other than active or suspended. For example, in some embodiments, one or more of the voice assistants 110a-e may be in a background state. In a background state, a voice assistant may, in some embodiments, include code that is loaded into memory, but it may operate on a low-priority thread. As another example, one or more of the voice assistants may be in an idle state. In an idle state, a voice assistant may, in some embodiments, include code that is loaded into memory, but read/write operations of the idle voice assistant may be temporarily paused. Furthermore, as is further described below (e.g., in connection with FIGS. 2-3 and FIGS. 5-6), states of the voice assistants 110a-e may be dynamic (e.g., voice assistant states may change in response to events).

In some embodiments, an active voice assistant may be loaded into memory. In some embodiments, an active voice assistant may be ready to receive and process an utterance without needing to be started. Furthermore, in some embodiments, an active voice assistant may be actively listening for an utterance from the user U. In some embodiments, an active voice assistant may be running in the background of the device 106 and may not be automatically suspended or put to sleep by an operating system of the device 106, even if the active voice assistant is not being used. A suspended voice assistant, on the other hand, may not, in some embodiments, be loaded into memory and may not be able to receive or process an utterance until the suspended voice assistant is activated. In some embodiments, an active voice assistant may consume more computer resources (e.g., RAM, battery life, processing time) than a suspended voice assistant.

In some embodiments, one of the voice assistants 110a-e may be removed from the plurality of voice assistants 110a-e, or a voice assistant may be added to the plurality of voice assistants 110a-e. Although illustrated as five voice assistants in the example of FIG. 1, there may be more or fewer voice assistants than those shown in the example of FIG. 1. Example voice assistants include Siri, Alexa, Cortana, Google Assistant, Hey Spotify, or other services that may interact with a user via voice. Each of the voice assistants 110a-e and the voice assistant controller 108 may be implemented as software, hardware, or a combination of software and hardware.

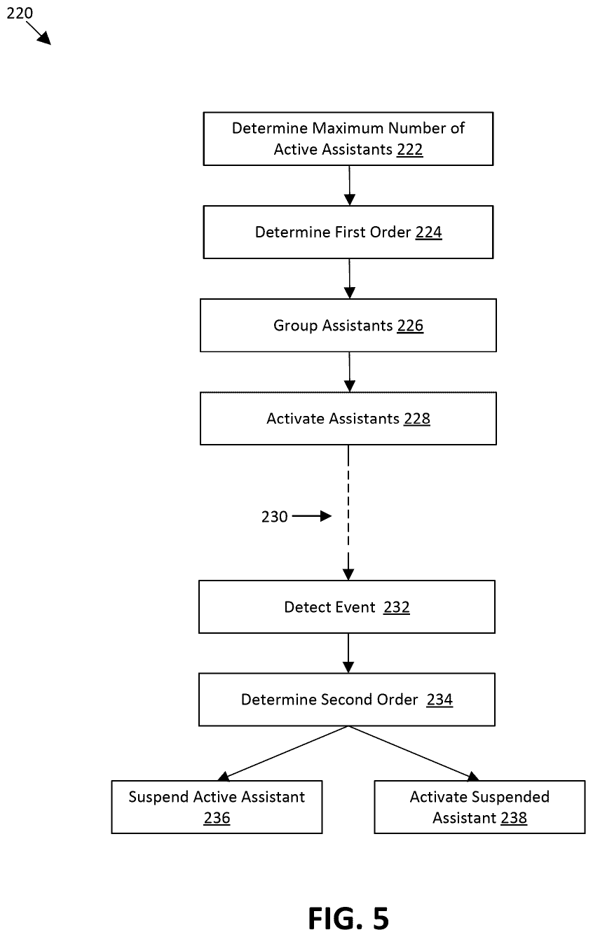

In some embodiments, in response to the event 112, the voice assistant controller 108 may alter an order of the voice assistants 110a-e or change an activation status of a voice assistant of the voice assistants 110a-e. The event 112 may be one of a plurality of possible events. For example, the event 112 may be an interaction with the user U (e.g., a voice input from the user or a change of user preferences), a change of a component of the device 106 (e.g., a change in a computer resource, such as an available memory or remaining battery life), a change in an external condition (e.g., a change in geographical location or a change in time, such as a transition into sleeping or working hours), or a change to the plurality of voice assistants 110a-e (e.g., an addition or removal of a voice assistant or an alteration to an existing voice assistant). In other embodiments, the event 112 may be associated with another type of event that causes the voice assistant controller 108 to alter an order of the voice assistants, activate a suspended voice assistant, suspend an active voice assistant, or change a number of active voice assistants. Examples of events are further described below in connection with FIG. 5.

In the example shown, the instance 102 of the device 106 is prior to the event 112, and the instance 104 of the device 106 is after the event 112. In the example of FIG. 1, the order of the voice assistants is different between the instance 102 and the instance 104. Furthermore, in the instance 102, there are two active voice assistants 106 (i.e., the voice assistants 110a and 110b), while the other voice assistants are suspended. In the instance 104, there are three active voice assistants (i.e., the voice assistants 110b, 110e, and 110c), while the rest are suspended. Thus, as shown in the example of FIG. 1, the voice assistant controller 108 determined a new order of voice assistants 110a-e, activated two voice assistants (e.g., the voice assistants 110c and 110e), and suspended a voice assistant (e.g., the voice assistant 110a), illustrating an example of operations that may be performed by the voice assistant controller 108 as part of managing the activation statuses of voice assistants.

As shown in the example of FIG. 1, the device 106 may include a plurality of voice assistants. As a result, a user may have access to a broad range of voice assistant functionality (e.g., voice assistants that perform different services, such as services related to playing or interacting with media, sending or receiving communications, executing search queries, controlling IoT devices, or performing other functions) while using the device 106. The ability to have multiple voice assistants on a single device may, in some instances, be enabled by aspects of the present disclosure. For instance, aspects of the present disclosure may dynamically coordinate voice assistant activation, thereby managing the quantity of computer resources consumed by voice assistants, which voice assistants are actively consuming computer resources, and when voice assistants are actively consuming computer resources.

Furthermore, aspects of the present disclosure may control voice assistant activation in response to detecting a variety of real-time events (e.g., user inputs, changes in available computer resources, or changes in external conditions). At the same time as controlling voice assistant activation, aspects of the present disclosure may also predict (e.g., by ordering voice assistants) which voice assistants a user is more likely to use and may activate those voice assistants in anticipation of user requests, thereby improving the overall response time and reducing computer operations when the user does, in fact, use one or more active voice assistants.

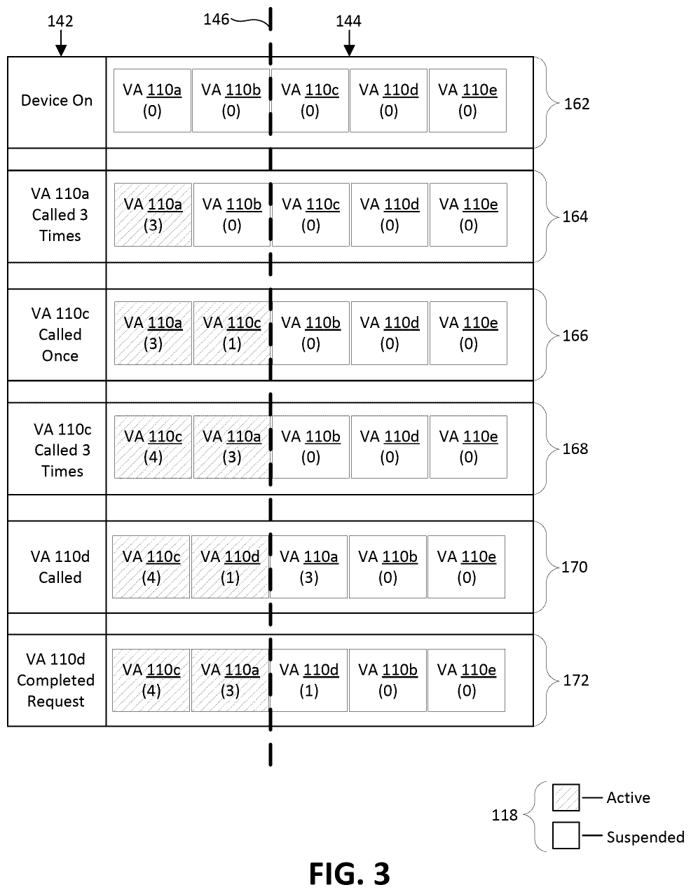

FIGS. 2-3 illustrate examples of managing voice assistants. FIGS. 2-3 include tables having an event column 142 and an assistant order column 144. In each of FIGS. 2-3, the rows of the tables include a plurality of steps (e.g., steps 132-140 in FIG. 2 and steps 162-172 in FIG. 3). Each of the steps in FIGS. 2-3 may correspond with an instance of the device 106. Additionally, some steps (e.g., the steps 164 and 168 of FIG. 3) may correspond with a plurality of instances of the device 106. Each of the steps in FIGS. 2-3 may include an event (e.g., as indicated in the event column 142) and an order of the voice assistants (VA) 110a-e (e.g., as indicated in the assistant order column 144) that is determined in response to the event. For the orders of voice assistants 110a-e, the left side represents higher ranked voice assistants while the right side represents lower ranked voice assistants.

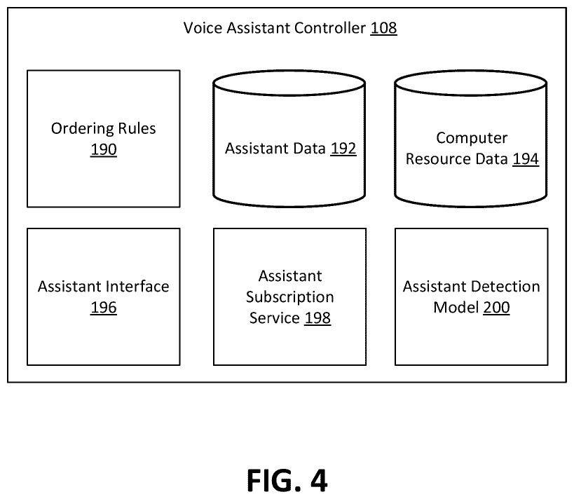

Still referring generally to FIGS. 2-3, the voice assistant controller 108 may determine the order of the voice assistants 110a-e in one or more of the illustrated steps. In some embodiments, the plurality of voice assistants 110a-e may be on the device 106, as illustrated in the example of FIG. 1. In some instances, the voice assistant controller 108 may, for each step, detect the event (e.g., an event in the event column 142) and, based at least in part of the event, determine an order of the voice assistants 110a-e (e.g., as illustrated in the assistant order column 144). To determine the order of the voice assistants 110a-e, the voice assistant controller 108 may, depending on the embodiment, apply one or more rules of the ordering rules 190, which are further described below in connection with FIG. 4. Furthermore, the voice assistant controller 108 may determine a maximum number of active voice assistants 146, as shown by the dashed line. In the example of FIG. 2, the maximum number of active voice assistants 146 is three, whereas in the example of FIG. 3, the maximum number of active voice assistants 146 is two. The maximum number of active voice assistants 146 may indicate the maximum number of voice assistants in a group of active voice assistants. In some embodiments, the maximum number of active voice assistants 146 may change, and there may, in some embodiments, be fewer active voice assistants than the maximum number of active voice assistants 146. In some embodiments, the voice assistant controller 108 may determine the maximum number of active voice assistants 146 upon startup of the device 106, during an initialization process, or at a different time. Determining the maximum number of active voice assistants is further described below in connection with FIG. 5.

In the example of FIG. 2, the voice assistant controller 108 orders the voice assistants 110a-e based on a recency of use, with voice assistants used recently ranked higher than voice assistants that have not been used as recently.

At step 132, the voice assistant controller 108 may detect that the device 106 is turned on. In some embodiments, each of the voice assistants 110a-e may be suspended when the device 106 is turned on, as shown in the example of FIG. 2. In other examples, however, the voice assistant controller 108 may automatically activate one or more of the voice assistants 110a-e at startup of the device 106. In some embodiments, an initialization operation (e.g., described at step 134) may be performed automatically upon startup. In some embodiments, an initialization process may be triggered by a user or another event.

At step 134, the voice assistant controller 108 may initialize the voice assistants. In some embodiments, the voice assistant controller 108 may randomly order the voice assistants 110a-e. In some embodiments, the voice assistant controller 108 may use a previous order of the voice assistants 110a-e to order the voice assistants (e.g., a previous order of the voice assistants 110a-e may persist and be retained between a reboot of the device 106). In some embodiments, the voice assistant controller 108 may initially order the voice assistants based on user preferences or based on a characteristic of the device 106. For instance, if voice assistant 110a is associated with a business entity related to the device 106 or to the voice assistant controller 108, then the voice assistant controller 108 may be configured to give priority to the voice assistant 110a when determining an order during initialization or when determining an order at other times.

In the example of FIG. 2, the maximum number of active voice assistants 146 indicates that three voice assistants may be active (e.g., as represented by the left side of the dashed line associated with the maximum number of active voice assistants 146). At step 134, the voice assistants 110a-c are the three highest-ranked voice assistants of the voice assistants 110a-e. In some embodiments, the voice assistant controller 108 may send activation instructions to the voice assistants 110a-c. On the other hand, the voice assistants 110d-e may remain suspended or receive deactivation instructions from the voice assistant controller 108.

At step 136, the voice assistant 110d is called. When a voice assistant is called (both at the step 136 and at other example steps referring to a voice assistant being called), a user may have sent an utterance to the device 106 directed at the called voice assistant. For example, the utterance may have included a wake word of the called assistant, or the utterance may have included a request that may be handled by the called assistant, as is further described below. In response to detecting that the voice assistant 110d is called, the voice assistant controller 108 may, among other things, determine a second order of the voice assistants 110a-e. For example, the voice assistant controller 108 may, based on a recency of use, move the voice assistant 110d to the front of the order, as shown in the step 136. Furthermore, the voice assistant controller 108 may activate the voice assistant 110d. However, to do so, the voice assistant controller 108 may, in some embodiments, have to suspend an active voice assistant, because activating the voice assistant 110d without suspending an active assistant may result in a number of active assistants exceeding the maximum number of active assistants 146. Thus, in some embodiments, the voice assistant controller 108 may, according to ordering rules applied by voice assistant controller 108, suspend the lowest-ranked active assistant (e.g., the voice assistant 110c) and then activate the voice assistant 110d. In some embodiments, the voice assistant controller 108 (or another component of the device 106) may communicate the utterance to the voice assistant 110d.

As illustrated by the step 136, the voice assistant controller 108 may create space in the memory for a called voice assistant (e.g., the voice assistant 110d) by suspending an active voice assistant (e.g., the voice assistant 110c). As a result, a user may be able to interact with a voice assistant even if, when the user sends a voice input, that voice assistant is not active. Furthermore, the user need not be aware of whether the desired voice assistant is active, as the voice assistant controller 108 may activate the called voice assistant if it is not, a feature that may, among other things, improve the user experience by making it easier to interact with a plurality of available voice assistants.

At step 138, the voice assistant 110e is called. In response to detecting that the voice assistant 110e is called, the voice assistant controller 108 may, among other things, determine another order of the voice assistants 110a-e, as illustrated in the step 138. Furthermore, the voice assistant controller 108 may activate the voice assistant 110e and suspend the voice assistant 110b. For example, the voice assistant controller 108 may determine, based on the updated order, that the voice assistant 110b is no longer part of the active group of assistants, and the voice assistant controller 108 may send it deactivation instructions.

At step 140, the voice assistant 110d is called. In response to detecting that the voice assistant 110d is called, the voice assistant controller 108 may determine another order of the voice assistants 110a-e, as illustrated in the step 140. In some embodiments, the voice assistant controller 108 may communicate an utterance to the voice assistant 110d. Because the voice assistant 110d is already active, the voice assistant controller 108 need not, in some embodiments, activate the voice assistant 110d, nor suspend a voice assistant to free up resources for the voice assistant 110d. As a result, time is saved by not having to activate the voice assistant 106d, and the voice assistant 106d may receive and begin processing a user request earlier than if the voice assistant 106d had not already been active. Furthermore, computer resources may be saved by reducing the number of operations that must be performed by the voice assistant controller 108. Thus, in some embodiments, by activating voice assistants based on a ranking, the voice assistants may operate more quickly, may operate with improved computational efficiency, and may save power of the device 106. As illustrated in the example of FIG. 2, ordering voice assistants based on a recency of use may be an accurate indicator of whether a user is likely to use that assistant again soon.

In FIG. 3, the voice assistant controller 108 determines the order of the voice assistants 110a-e based on a popularity. For example, the voice assistants may be ordered based on their historical usage, with voice assistants used more often ranked higher than voice assistants used less often. As is further described below in connection with FIG. 4, popularity may also, in some embodiments, be tracked over a time (e.g., popularity over the last month or year, or popularity during a certain time of the day). As shown in the example of FIG. 3, the voice assistant controller 108 may track how many times each of the voice assistants has been called (e.g., as indicated by the number in parentheses below each voice assistant). The voice assistant controller 108 may, for example, track such data in a database of assistant data 192, which is further described below in connection with FIG. 4.

At step 162, the device may turn on. As described above in connection with step 132 of FIG. 2, when the device is turned on, each of the voice assistants 110a-e may be suspended. Furthermore, as illustrated in the example of FIG. 3, the voice assistant controller 108 may not, in some embodiments, perform an initialization process. As a result, in some examples, a voice assistant may not be activated until it is to be used. In this example, the active group of assistants may, at step 164, consist of only the voice assistant 110a and then, at step 166, the active group may include the voice assistant 110a and the voice assistant 110c, thereby exemplifying that the active group of assistants may, in some instances, include fewer assistants than the maximum number of active voice assistants 146.

At step 164, the voice assistant 110a is called three times. For example, a user may direct a first utterance at the voice assistant 110a. In response to detecting the first utterance, the voice assistant controller 108 may determine an order of the voice assistants 110a-e and activate the voice assistant 110a. Furthermore, the user may, at a second time, direct a second utterance at the voice assistant 110a. In response to detecting the second utterance, the voice assistant controller 108 may or may not determine an order of the voice assistants 110a-e. However, even if the voice assistant controller 108 redetermines the order of voice assistants 110a-e, the order may be unchanged. Furthermore, at a third time, the user may direct a third request at the voice assistant 110a. This series of calls represents one example of how the voice assistant 110a may have been called three times.

At step 166, the voice assistant 110c is called once. In response, the voice assistant controller 108 may determine an order of the voice assistants 110a-e, as illustrated by the step 166. Furthermore, the voice assistant controller 108 may activate the voice assistant 110c and, in some embodiments, communicate an utterance to the voice assistant 110c. As illustrated, however, the voice assistant 110a remains ranked ahead of the voice assistant 110c, as the voice assistant 110a has been used three times whereas the voice assistant 110c has only been used once.

At step 168, the voice assistant 110c is called three times. At each call of the voice assistant 110c, the voice assistant controller 108 may determine an order of the voice assistants 110a-e. However, a new order may not result until the third or fourth call of the voice assistant 110c, in response to which the voice assistant controller 108 may rank the voice assistant 110c in front of the voice assistant 110a.

At step 170, the voice assistant 110d is called. In response to detecting that the voice assistant 110d is called, the voice assistant controller 108 may, in some embodiments, temporarily activate the voice assistant 110d, so that the voice assistant 110d can receive and process the request it was called for. Furthermore, the voice assistant controller 108 may also temporarily suspend an active voice assistant, such as the lowest-ranking voice assistant of the active voice assistants (e.g., the voice assistant 110a), thereby creating, in some embodiments, available computer resources for the voice assistant 110d.

At step 172, the voice assistant controller 108 may detect that the voice assistant 110d completed a request (e.g., the request it was activated to handle in the step 170). In response to detecting that the voice assistant 110d completed the request, the voice assistant controller 108 may determine an order of the voice assistants 110a-e, as illustrated by the step 172. As shown, because the voice assistant 110a has been called more frequently than the voice assistant 110d, the voice assistant controller 108 may rank the voice assistant 110a ahead of the voice assistant 110d. Based on the order, the voice assistant controller 108 may reactivate the voice assistant 110a and suspend the voice assistant 110d. As illustrated by the steps 170-172, the voice assistant controller 108 may temporarily suspend an assistant and temporarily activate an assistant to handle a particular request. However, in some instances, once the temporarily active assistant has completed the request, the voice assistant controller 108 may redetermine an order of the voice assistants and, based at least in part on the order, reactivate the temporarily suspended assistant and suspend the temporarily active assistant. In some instances, there may be an elapse of time between the step 170 and the step 172 (e.g., as the voice assistant 110d processes a request). Despite a possible elapse of time, the voice assistant controller 108 may, in some embodiments, retain information related to the order of the voice assistants 110a-e, thereby enabling the voice assistant controller 108 to reactivate the voice assistant 110a. Thus, the voice assistant controller 108 may provide the functionality of a suspended voice assistant (e.g., by temporarily activating the suspended assistant) while also maintaining active those voice assistants that, according to ordering rules (e.g., ordering by historical usage), are ranked higher and may be more likely to be used.

FIGS. 2-3 represent only some of the ways that the voice assistant controller 108 may order the voice assistants 110a-e. They represent two possible rule sets of a plurality of ordering rules 190 that may be deployed by the voice assistant controller 108. In the example of FIG. 2, the voice assistant controller 108 ranked assistants based in part on recency. In the example of FIG. 3, the voice assistant controller ranked assistants based in part on historical usage. Other possible ordering rules are further described below in connection with FIG. 4.

FIG. 4 illustrates a schematic block diagram of example aspects of the voice assistant controller 108. In the example shown, the voice assistant controller 108 includes a plurality of components, including ordering rules 190, assistant data 192, computer resource data 194, an assistant interface 196, an assistant subscription service 198, and an assistant detection model 200. Each of the components of the voice assistant controller 108 may be implemented using software, hardware, or a combination of software and hardware. Additionally, in some examples, the voice assistant controller 108 may include more or fewer components than those illustrated in the example of FIG. 4. Furthermore, depending on the embodiment, components of the voice assistant controller 108 may be configured to perform different operations than those described herein. Additionally, depending on the embodiment, an operation may be performed by a different component—or combination of components—than described herein.

The ordering rules 190 may be a collection of rules that define how the voice assistants 110a-e are ordered. In some embodiments, the rules may include an ordered set of steps for ranking the voice assistants 110a-e. Depending on the embodiment, the voice assistant controller 108 may deploy one or more rules of the ordering rules 190 when determining an order of the voice assistants 110a-e. In some embodiments, rules may be used to determine a score for voice assistants, and the voice assistants may be ordered based on their scores. In the example of FIG. 2, the voice assistant controller 108 deployed rules that ordered the voice assistants 110a-e based on a recency of use. In the example of FIG. 3, the voice assistant controller 108 deployed rules that ordered the voice assistants 110a-e based on a popularity (e.g., as determined by historical usage). The ordering rules 190 may include more possible rules than those described in connection with FIGS. 2-3.

For example, the ordering rules 190 may include rules that order voice assistants based on time. For example, the rules may rank certain voice assistants higher at certain times. For instance, the rules may rank a voice assistant related to sending communications higher during the day, or on weekdays, and a voice assistant related to playing media content higher at night, or on weekends. For such rules, a user or administrator of the voice assistant controller 108 may define rankings of the voice assistants for various times (e.g., for user-defined time frames, for times defined by the device 106 or the voice assistant controller 108, or for other time frames).

As another example, the ordering rules 190 may include rules that order voice assistants based on user preferences. For example, the voice assistant controller 108 may, in some embodiments, receive input from a user (e.g., an input via voice or an input via a user interface displayed by the device 106) defining the user's voice assistant preferences. The user input may define a full ordering of the voice assistants, it may define a particular position of a voice assistant (e.g., voice assistant 106c is first), or it may define a relative ranking of voice assistants (e.g., voice assistant 106d is ranked ahead of voice assistant 106a). In some embodiments, the voice assistant controller 108 may infer the user's voice assistant preferences based on user data (e.g., user profile data or data given by the user related to the user's interests). In some embodiments, the voice assistant controller 108 may infer user preferences based on an order of voice assistant icons. For example, a device 106 may include a display having icons associated with one or more of the voice assistants 110a-e. The user may order the icons (e.g., by placing an icon on a first page, or first position, and another icon on a later page, or later position). Based on icon placement, the voice assistant controller 108 may, in some embodiments, infer the user's preferences relating to an order of the voice assistants. Furthermore, for a situation in which there may be multiple users, the voice assistant controller 108 may, in some embodiments, determine a user that it is interacting with and order the voice assistants based on that user's preferences, because each user may have different voice assistant preferences.

As another example, the ordering rules 190 may include rules that order voice assistants based on a popularity over a time or at a time. For example, the relevant span of time may be the most recent hour, day, week, month, year, or other span of time. In such an example, the more popular a voice assistant has been over the relevant span of time (e.g., the last month), the higher the voice assistant is ranked. As another example, the time may be a recurring time period, such as a certain time of the day or day of the week (e.g., the rules may rank the voice assistants based on their popularity at a certain time of day, such as between 6 P.M. and 10 P.M., or on a certain day, such as Sundays). Then when the recurring time period occurs, the voice assistant controller 108 may, in some embodiments, apply the rule that tracks popularity for that time period. For instance, if the voice assistant 110e is the most popular voice assistant between 6 P.M. and 10 P.M., then it will be ranked highest during that time period.

As another example, the ordering rules 190 may include rules that order voice assistants based on a general popularity. A general popularity may be based on historical usage that is not specific to a particular user. For example, the voice assistant controller 108 may aggregate data across users, or across devices, to determine a general voice assistant popularity and, based on this popularity, the voice assistants may be ranked. Similarly, the general popularity may be determined based on voice assistant popularity for defined groups of users (e.g., users located in Texas between the ages of 30 and 40). Relatedly, the rules may include ordering voice assistants based on a general popularity over a span of time or for a time period. In a non-limiting example, the popularity is defined by the number of times a voice assistant is signaled.

As another example, the ordering rules 190 may include rules that order voice assistant based on geography. In some embodiments, the voice assistant controller 108 may detect a location of the user and rank the voice assistants based on the location. For example, the rules may indicate that a voice assistant for managing IoT devices is ranked higher while the user is at home, while a voice assistant that executes search queries is ranked higher while the user is traveling. As another example, the rules may indicate that certain voice assistants are ranked higher when it is detected that the user is traveling in a car.

As another example, the ordering rules 190 may include rules that order voice assistants based on features of the device 106. For example, when the device includes certain components (e.g., certain input/output devices), certain voice assistants may be ranked higher than others. For example, if the device 106 does not have a screen, then voice assistants primarily related to displaying visual content may be ranked lower. As another example, a ranking of voice assistants may depend on devices that the device 106 is connected to. For instance, if the device 106 is connected to a system in a car, then voice assistants related to navigation, media content, or communications may be ranked higher. As another example, if the device 106 is connected to an external speaker, then voice assistants related to playing media content may be ranked higher.

As another example, the ordering rules 190 may include rules that order voice assistants based in part on assistant similarity. For example, the rules may include one or more steps for determining assistant similarity. In some embodiments, assistants that are configured to provide similar services are more similar than those that are not configured to provide similar services. In some embodiments, the ranking of an assistant may affect the ranking of similar assistants. For example, if an assistant related to sports is ranked high (e.g., because it has frequently been used), then other sports-related assistants may receive a boost to their ranking (e.g., by boosting a score of the sports-related assistants). As a result, it may, in some embodiments, be more likely that similar assistants are active at the same time, thereby anticipating that the user may—following a request to an assistant—direct a subsequent request to a similar assistant.

As another example, the ordering rules 190 may include rules that give priority to voice assistants that are called or that are processing a request. For example, if a voice assistant is called, then the rules may indicate that the called voice assistant is automatically in the active group of assistants until it has finished processing an utterance.

As another example, the ordering rules 190 may include rules dictating that a voice assistant is suspended if its historic usage is below a minimum amount. In some embodiments, such rules may track voice assistant usage during certain time periods. If a voice assistant has historically not been called during that time period (or has only been called fewer than a threshold number of times), then that voice assistant may be suspended. As an example, the voice assistant controller 108 may determine that no voice assistants have been used between 11 PM and 6 AM. As a result, the voice assistant controller may suspend all voice assistants during that time, even if there are computer resources available for one or more voice assistants to be active. As a result, power consumption is further reduced during times that a voice assistant may be unlikely to be called.

Furthermore, in some examples, the voice assistant controller 108 may use a combination of one or more rules in the ordering rules 190 when determining an order of the voice assistants. Furthermore, in some embodiments, the voice assistant controller 108 may break ties between voice assistants by randomly breaking ties or by applying another set of rules (e.g., if two assistants are tied in historical usage, the voice assistant controller 108 may break the tie based on which was used more recently). In some embodiments, a user may define which rules of the ordering rules 190 are used by the voice assistant controller. In some embodiments, the rules may be selected by the voice assistant controller 108 itself, or by an administrator of the voice assistant controller 108 or of one of the voice assistants 110a-e. In some embodiments, the voice assistant controller 108 may switch from one rule set of the ordering rules 190 to another rule set of the ordering rules 190 (e.g., in response to a user input, a change in the device 106, a detection that the currently applied rule set is not producing expected results).

The assistant data 192 may include data related to the voice assistants 110a-e. In some embodiments, the assistant data 192 may include data related to a current order of the voice assistants and, in some embodiments, data related to one or more past orders of the voice assistants 110a-e. In some embodiments, the order of the voice assistants 110a-e may be implemented as a data structure such as a list, binary tree, or priority queue. In some embodiments, the voice assistant data 192 may also include data that may be used by the voice assistant controller 108 when determining an order of the voice assistants 110a-e (e.g., historical usage data, user preference data, assistant similarity data, assistant scores, or other data that may be used when applying one or more of the ordering rules 190). The assistant data 192 may also include data related to computer resources consumed by each of the voice assistants 110a-e, such data including both when the voice assistant is active and suspended. Furthermore, the assistant data 192 may include other data that may be used by the voice assistant controller 108 when interacting with the voice assistants 110a-e.

The computer resource data 194 may include data related to computer resources of the device 106. In some embodiments, the computer resource data 194 may include data related to how much memory (e.g., RAM) is available. In some embodiments, computer resource data 194 may include data related to how much storage space is available. In some embodiments, computer resource data 194 may include data related to available processing power. In some embodiments, the computer resource data 194 may include data related to battery capacity or remaining battery life. Furthermore, in some embodiments, the voice assistant controller 108 may monitor computer resource usage and availability by using the computer resource data 194. Accordingly, the voice assistant controller 108 may be able to detect a change in one or more computer resources (e.g., available memory or storage being above or below a certain amount, or the battery life being above or below a certain value).

The assistant interface 196 may handle communication between the voice assistant controller 108 and the voice assistants 110a-e. In some embodiments, the assistant interface 196 may generate and send activation instructions or deactivation instructions to one or more of the voice assistants 110a-e. In some embodiments, the assistant interface 196 may communicate an utterance from a user to one or more of the voice assistants 110a-e. Furthermore, in some embodiments, the voice assistant controller 108 may send other data to one or more of the voice assistants 110a-e, such as one or more of the following: a compressed or uncompressed digital audio file of the utterance, data related to the user who sent the utterance (e.g., user profile or identity data), data related to the device 106 (e.g., the device type, device operating system, IMEI number, or other device data), time data related to the utterance (e.g., when the utterance was sent, received, or processed), or location information (e.g., of the device 106 or the user). Furthermore, in some embodiments, the assistant interface 196 may receive a response generated by one or more of the voice assistants 110a-e.

The assistant subscription service 198 may handle the subscription of a new voice assistant, manage a change to a voice assistant, or unsubscribe a voice assistant. In some examples, the voice assistant controller 108 may expose the assistant subscription service 198 using an application programming interface (API) that a voice assistant may call to subscribe to the voice assistant controller 108. As part of subscribing a voice assistant, the assistant subscription service 198 may receive data related to a voice assistant, such as the following: one or more wake words or wake phrases associated with the voice assistant; a category of the voice assistant; a functionality of the voice assistant; or details related to computer resources consumed by the voice assistant. The assistant subscription service 198 may also communicate with other components of the voice assistant controller 108 regarding changes to a voice assistant. For example, the assistant subscription service 198 may update one or more of the ordering rules 190, assistant data 192, the computer resource data 194, the assistant interface 196, or the assistant detection model 200.

The assistant detection model 200 may include one or more models for detecting a voice assistant that is associated with an utterance. For example, the assistant detection model 200 may include one or more models for detecting a wake word in an utterance. Once the wake word is detected, the voice assistant controller 108 may determine an assistant associated with the wake word, thereby detecting which of the voice assistants is called. As another example, the voice assistant controller 108 may include a category detection model that may detect a category or action of an utterance. Based on the detected category or action, the voice assistant controller 108 may determine which one or more voice assistants may handle the utterance, thereby detecting which of the voice assistants is called. In some embodiments, the assistant detection model may include one or more machine learning models.

FIG. 5 is a flowchart of an example method 220. In some examples, the method 220 may be performed by the voice assistant controller 108.

The method 220 may begin at operation 222. At operation 222, the voice assistant controller 108 may determine a maximum number of voice assistants that may be active. For example, in FIGS. 2 and 3, the voice assistant controller 108 determined that 3 and 2 assistants may be active, respectively. In some embodiments, the voice assistant controller 108 may determine how many voice assistants may be active based on available computer resources (for example, the number of parallel or serial processing threads, the percentage of memory, and or the number of engaged/used cores or cells of the processors, battery life and so on). As one example, the voice assistant controller may determine that, based on one or more of an available memory, a battery life, or a processing power, a certain number of assistants may be active. For example, the voice assistant controller 108 may compare the computer resources required by the voice assistants 110a-e to determine how many, given the available computer resources, can be active a time. In some embodiments, as the status of computer resources changes, the maximum number of active voice assistants may also change (e.g., if more memory becomes available, more assistants may be active, or if battery life lowers, then less assistants may be active). Furthermore, in some embodiments, as the status of computer resources changes, the timing of voice assistant activation and activation patterns of the voice assistants may also change. For example, if more computer resources are detected to be available, then multiple voice assistants may be activated or suspended concurrently, whereas if fewer computer resources are available, then changes to voice assistant states may be performed sequentially.

In some embodiments, the voice assistant controller 108 may determine a maximum number of active voice assistants based on factors besides computer resources. For example, the voice assistant controller 108 may determine a maximum number of active voice assistants based on a user input (e.g., a user input indicating that a certain number of voice assistants may be active, or a most recent user input selecting one or more voice assistants). In some embodiments, the maximum number of active voice assistants may be based on the historical usage data/pattern of the user. For example, the voice assistant controller 108 may detect that, based on historical usage, voice assistants are unlikely to be called during a certain time period (e.g., between 11 PM and 6 AM), and the voice assistant controller 108 may set a low value (e.g., 0 or 1) for the maximum number of active voice assistants during that time period, even if a device may have sufficient available compute resources to run more active voice assistants during that time period.

At operation 224, the voice assistant controller 108 may determine a first order of the voice assistants. For example, the voice assistant controller 108 may apply one or more rules of the ordering rules 190 to the voice assistants 110a-e. Furthermore, as described above, the voice assistant controller 108 may use data related to the voice assistants when ordering the voice assistants 110a-e. In some embodiments, the voice assistant controller 108 may randomly order the voice assistants (e.g., on a reboot of the device 106, or if there is insufficient data to otherwise order the voice assistants 110a-e). As a result of ordering the voice assistants 110a-e, the voice assistants 110a-e may be ranked. In some embodiments, the ordering of the voice assistants 110a-e may include operations on a data structure, such as a list, priority queue, or binary tree.

At operation 226, the voice assistant controller 108 may group the voice assistants 110a-e. In some embodiments, the voice assistant controller 108 may group the voice assistants into an active group of assistants and a suspended group of assistants. To form the groups, the voice assistant controller 108 may, in some embodiments, use the ordering of the voice assistants 110a-e (e.g., as determined at the operation 224). Furthermore, in some embodiments, the voice assistant controller 108 may use the maximum number of active voice assistants (e.g., as determined at the operation 222). For example, if there are X voice assistants that are ranked from 1 to X (where 1 is the highest ranking and X is the lowest ranking) and if the maximum number of active voice assistants is N, then the voice assistants in the positions 1 to N of the ordering may be included in the active group of voice assistants, whereas voice assistants in the position N+1 to X may be included in the suspended group of assistants.

In some embodiments, as the order of the voice assistants changes, the composition of the active and suspended groups may also change. Furthermore, as the maximum number of active voice assistants changes, the composition of the active and suspended groups may also change. In some embodiments, the voice assistant controller 108 may use other methods for determining active and suspended voice assistants. For example, if a suspended voice assistant is called, then, in some embodiments, the called voice assistant may be temporarily added to the group of active voice assistants, while an active voice assistant may be temporarily removed from the active group of assistants and added to the suspended group of assistants.

At operation 228, the voice assistant controller 108 may activate assistants. In some embodiments, the voice assistant controller 108 may activate each voice assistant in the active group of voice assistants. In some embodiments, the voice assistant controller 108 may activate fewer than all of the voice assistants in the active group of assistants (e.g., if one or more of the voice assistants in the active group is already active). Additionally, in some embodiments, the voice assistant controller 108 may suspend one or more voice assistants prior to activating voice assistants. In some embodiments, the voice assistant controller 108 may generate activation instructions and send them to voice assistants that are being activated. For instance, the voice assistant controller 108 may generate activation instructions that are specific to each voice assistant that is being activated. In some embodiments, the voice assistant controller 108 may use a configuration file of an assistant to generate activation instructions for that assistant, or the voice assistant controller 108 may use other information in the assistant data 192 to generate activation instructions.

As illustrated by the break 230, there may be a passage of time before the voice assistant controller 108 proceeds to the operation 232. In some embodiments, the break 230 may persist until an event is detected. Thus, the voice assistants activated at operation 228 may be activate during the break 230. In some embodiments, during the break 230, the voice assistants activated at the operation of 228 may be actively listening for their wake word or may be ready to receive a request.

At operation 232, the voice assistant controller 108 may detect an event. An event may be one of a plurality of possible occurrences. An example event 112 is described above in connection with FIG. 1.

One example of an event may be a change in computer resources. For example, the voice assistant controller 108 may monitor computer resources, including, for example, memory, battery life, and processing power. In one example, the voice assistant controller 108 may determine, based on the available memory, how many voice assistants may be active. Furthermore, the voice assistant controller 108 may detect when there is a change in memory (e.g., because other applications were started or stopped, or because memory was added or removed). As another example, the voice assistant controller 108 may detect when a battery life changes. For instance, if the battery life becomes higher or lower than a value, the voice assistant controller 108 may detect that change (e.g., the battery life goes below 25%, a condition which may reduce the number of voice assistants that are active). Furthermore, in other embodiments, the voice assistant controller 108 may detect other changes in computer resources. In some embodiments, the voice assistant controller 108 may monitor computer resources by querying the computer resource data 194. In some embodiments, the voice assistant controller 108 may receive a notification that a relevant change in computer resources has occurred. In some embodiments, a change in computer resources may be caused by the device 106 connecting to another device. For instance, if the device 106 connects to a system in a car, or to an external system, then this may indicate a change in the computer resources (e.g., displays, speakers, microphones, etc.) available to the device 106.

Another example of an event may be a user preference change. For example, in some embodiments, a user may define voice assistant preferences. For instance, the user preferences may include a preferred order of the voice assistants, or the user preferences may indicate that a user prefers one assistant over another. In some embodiments, the user may change his or her preferences. In some embodiments, the voice assistant controller 108 may cause the device 106 to provide an opportunity to input user preferences (e.g., by displaying a user interface with one or more input fields for receiving a user preference, or by sending the user a voice message that requests the user's preferences). In some embodiments, there may be a plurality of users that use the device 106, each of which may have different preferences. In such a situation, the order of the voice assistants 110a-e may depend on which of the users is interacting with the device 106. In some embodiments, the voice assistant controller 108 may, in response to detecting a change in user preferences, update user preference data.

Another example of an event may be a change to voice assistant icons on a display. For example, one or more of the voice assistants 110a-e may be associated with an icon that is displayed on the device 106. In some embodiments, the user may arrange the order of these icons (e.g., placing some on a first page, or in a first position, while placing others on a later page, or later position). In some embodiments, the voice assistant controller 108 may apply an ordering rule that incorporates the position of voice assistant icons when determining the order of the voice assistant icons. Thus, in some embodiments, a change to voice assistant icons may be an event detected by the voice assistant controller 108.

Another example of an event may be a change to the voice assistants 110a-e. For example, a new voice assistant may subscribe with the voice assistant controller 108 and be added to the voice assistants 110a-e. As another example, a voice assistant 110a-e may be removed (e.g., the removed voice assistant may have been uninstalled from the device 106). As another example, a voice assistant may be updated (e.g., a voice assistant may have functionality added or removed, or may be changed in some other way). In some embodiments, the voice assistant controller 108 may, in response to detecting a change to the voice assistants 110a-e, update the assistant data 192.

Another example of an event may be a change in a condition that the voice assistant controller 108 is configured to detect. In some embodiments, the condition may relate to time. For instance, the event may be a passage of a certain amount of time, a transition from a first time period to a second time period (e.g., moving from working hours to at-home hours, moving into sleep hours, etc.) a transition from one day to the next, a transition from one month to the next, or another condition related to time. As another example, the condition may relate to location. For example, the event may be a detected location change of the user or the device 106 from a first location to a second location (e.g., from work to home). As another example, the event may be a detection that the user is in a car (e.g., as detected by the user's speed). In another example, the condition may relate to a detected change in an ambient condition, such as a weather condition or a noise level. In yet other examples, the condition may relate to other aspects of the device 106, a user, or external condition that may affect a usage of a voice assistant.

Another example of an event may be a change to one or more ordering rules, to a selection of ordering rules, or to data used in the ordering rules. For example, a user or an administrator of the device 106 may switch which ordering rules to apply to the voice assistants 110a-e. As another example, the voice assistant controller 108 or the device 106 may receive an update that alters one or more ordering rules. As another example, data used by the ordering rules may change (e.g., assistant popularity data or other data).

Another example of an event may be an action performed by one or more of the voice assistants 110a-e. For example, a voice assistant may process an utterance, which may include generating a response to a request of the utterance. As another example, a voice assistant may generate an error in response to not being able to process a request.

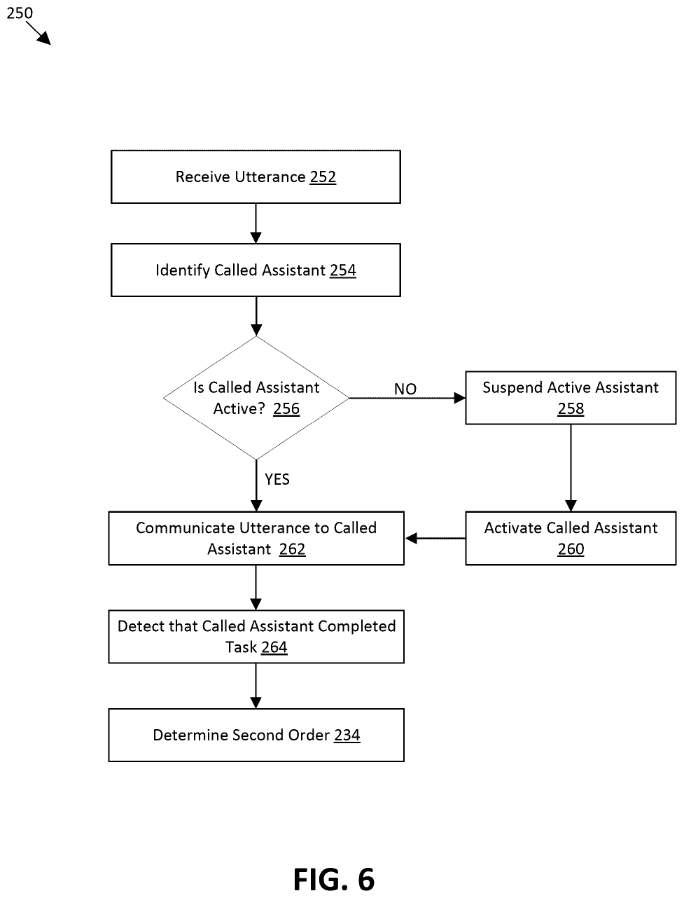

Another example of an event may be receiving a user utterance. Detecting receipt of a user utterance as an event is further described below in connection with FIG. 6.

In some embodiments, an event may be a different type of occurrence that causes the voice assistant controller 108 to perform one or more of altering an order of voice assistants, activating a suspended voice assistant, or suspending an active voice assistant. In some embodiments, the events that may be detected by the voice assistant controller 108 may depend on the rules used by the voice assistant controller 108 to order the voice assistants 110a-e.

At operation 234, the voice assistant controller 108 may determine a second order. For example, the voice assistant controller 108 may apply ordering rules to the voice assistants 110a-e. In some embodiments, the voice assistant controller 108 may apply the same ordering rules as those applied at the operation 224. In some embodiments, the second order of the voice assistants may be different than the first order. In some instances, however, the second order may be the same as the first order. In some instances, even if the second and the first order are the same, there may still be a change to which voice assistants are active and which are suspended (e.g., if the maximum number of active voice assistants changes). In some examples, the change in order may be caused by the event detected at the operation 232. In some embodiments, the voice assistant controller 108 may, based at least in part of the second order, determine an updated active group of assistants and an updated suspended group of assistants.

Following operation 234, the voice assistant controller 108 may, in some embodiments, perform one or more of the operation 236 or the operation 238. In some embodiments, the voice assistant controller 108 may, following the operation 234, regroup the voice assistants. For example, if the order of the voice assistants changed from the first order to the second order, there may, in some instances, be one or more voice assistants that were ranked lower than the Nth position (where N is the maximum number of active voice assistants determined at operation 222) in the first order but are ranked at or higher than the Nth position in the second order. Such one or more voice assistants may be moved from the suspended group to the active group. On the other hand, there may, in some instances, be one or more voice assistants that were ranked at or higher than the Nth position in the first order but that are ranked lower than Nth position in the second order. Such voice assistants may be moved from the active group to the suspended group. Furthermore, in some instances, the value of N may change (e.g., in response to the voice assistant controller 108 determining a different maximum number of voice assistants), thereby changing, in some embodiments, which voice assistants are in the active group, and which are in the suspended group.

At operation 236, the voice assistant controller 108 may suspend an active assistant. For example, in some instances, the voice assistant controller 108 may send deactivation instructions to one or more voice assistants that were moved from the active group to the suspended group.

At operation 238, the voice assistant controller 108 may activate a suspended assistant. For example, in some instances, the voice assistant controller 108 may send activation instructions to one or more voice assistants that were moved from the suspended group to the active group.

FIG. 6 is a flowchart of an example method 250. In some embodiments, aspects of the method 250 may be performed by the voice assistant controller 108. In some embodiments, aspects of the method 250 (e.g., the operations 252-264) may be performed as part of performing the method 220 of FIG. 5. In some instances, aspects of the method 250 (e.g., the operations 252-264) may be performed prior to determining a second order of the voice assistants 110a-e. In some embodiments, the method 250 may begin by detecting an event, which in the example of FIG. 6, is receiving an utterance from a user.

At operation 252, the voice assistant controller 108 may receive an utterance (e.g., a voice input, a voice command, a voice request, etc.) from a user. In some embodiments, the utterance may be received by a voice assistant that is actively listening for voice input. In some embodiments, an utterance may include a wake word and a request. A wake word may be one or more words that is associated with one of the voice assistants 110a-e. As part of receiving the utterance, the voice assistant controller 108—or another component of the device 106—may perform one or more tasks related to natural language processing or natural language understanding (e.g., identifying the speech, converting the speech to text, identifying words in the speech, wake word identification, etc.).

At operation 254, the voice assistant controller 108 may identify a called assistant. In some embodiments, the voice assistant controller 108 may use one or more models to detect a wake word in the utterance and, based on the detected wake word, the voice assistant controller 108 may identify which of the voice assistants 110a-e was called. In some embodiments, the voice assistant controller 108 may identify which of the voice assistants was called based on a detected category or action of the utterance. In some embodiments, a plurality of called voice assistants may be identified.

At decision 256, the voice assistant controller 108 may determine whether the called assistant is active. In response to determining that the called assistant is active, the voice assistant controller 108 may proceed to the operation 262 (e.g., taking the “YES” branch). In response to determining that the called assistant is not active, the voice assistant controller 108 may proceed to the operation 258 (e.g., taking the “NO” branch).

At operation 258, the voice assistant controller 108 may suspend an active assistant. In some embodiments, the voice assistant controller 108 may use the order of voice assistants to select an active assistant to suspend. For instance, the voice assistant controller 108 may suspend the active assistant having the lowest ranking of active assistants. In some embodiments, the voice assistant controller 108 may select a plurality of voice assistants to suspend. In some embodiments, the voice assistant suspended at the operation 258 is temporarily suspended, as it may be reactivated when a second order is determined (e.g., at the operation 234).

At operation 260, the voice assistant controller 108 may activate the called assistant (e.g., the assistant identified at operation 254). In some embodiments, the voice assistant controller 108 may send the called voice assistant activation instructions. In some embodiments, the called assistant is only temporarily activated, as it may be suspended when a second order is determined (e.g., at the operation 234).

At operation 262, the voice assistant controller 108 may communicate the utterance to the called assistant. In some embodiments, the voice assistant controller 108 may also transmit other data to the called voice assistant. For example, the voice assistant controller 108 may send any one or more of a compressed or uncompressed digital audio file of the utterance, data related to the user who sent the utterance (e.g., user profile or identity data), data related to the device 106 (e.g., the device type, device operating system, IMEI number, or other device data), time data related to the utterance (e.g., when the utterance was sent, received, or processed), or location information (e.g., of the device 106 or the user).

At operation 264, the voice assistant controller 108 may detect that the called assistant completed a task. There may be various ways to detect that a voice assistant completed a task. For example, the voice assistant controller 108 may detect that the called assistant fulfilled a request of the utterance. As another example, the voice assistant controller 108 may receive a response or an error from the called voice assistant.

At operation 234, the voice assistant controller 108 may determine the second order, as described above in connection with FIG. 5. In some examples (e.g., depending on what ordering rules are applied by the voice assistant controller 108), the called assistant may not, according to the second order, be included in the active group of assistants. In such a case, the voice assistant controller 108 may suspend the called assistant (e.g., at the operation 236 of FIG. 5). Furthermore, in some embodiments, the assistant suspended at operation 258 (or another voice assistant) may, according to the second order, be included in the active group of assistants. In such a case, the voice assistant controller 108 may activate that assistant if it is not already active (e.g., at the operation 238 of FIG. 5).

FIG. 7 illustrates an example system 280 with which disclosed systems and methods can be used. In an example, the following can be implemented in one or more systems 280 or in one or more systems having one or more components of system 280: the device 106, the voice assistant controller 108, the voice assistants 110a-e, the ordering rules 190, the assistant data 192, the computer resource data 194, the assistant interface 196, the assistant subscription service 198, the assistant detection model 200, and other aspects of the present disclosure.

In an example, the system 280 can include a computing environment 282. The computing environment 282 can be a physical computing environment, a virtualized computing environment, or a combination thereof. The computing environment 282 can include memory 284, a communication medium 292, one or more processing units 294, a network interface 296, and an external component interface 298.

The memory 284 can include a computer readable storage medium. The computer storage medium can be a device or article of manufacture that stores data and/or computer-executable instructions. The memory 284 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices or articles of manufacture that store data.

The memory 284 can store various types of data and software. For example, as illustrated, the memory 284 includes software application instructions 286, one or more databases 288, as well as other data 290. The communication medium 292 can facilitate communication among the components of the computing environment 282. In an example, the communication medium 292 can facilitate communication among the memory 284, the one or more processing units 294, the network interface 296, and the external component interface 298. The communication medium 292 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communication medium.

The one or more processing units 294 can include physical or virtual units that selectively execute software instructions, such as the software application instructions 286. In an example, the one or more processing units 294 can be physical products comprising one or more integrated circuits. The one or more processing units 294 can be implemented as one or more processing cores. In another example, one or more processing units 294 are implemented as one or more separate microprocessors. In yet another example embodiment, the one or more processing units 294 can include an application-specific integrated circuit (ASIC) that provides specific functionality. In yet another example, the one or more processing units 294 provide specific functionality by using an ASIC and by executing computer-executable instructions.

The network interface 296 enables the computing environment 282 to send and receive data from a communication network. The network interface 296 can be implemented as an Ethernet interface, a token-ring network interface, a fiber optic network interface, a wireless network interface (e.g., Wi-Fi), Bluetooth interface, or another type of network interface.

The external component interface 298 enables the computing environment 282 to communicate with external devices. For example, the external component interface 298 can be a USB interface, Thunderbolt interface, a Lightning interface, a serial port interface, a parallel port interface, a PS/2 interface, or another type of interface that enables the computing environment 282 to communicate with external devices. In various embodiments, the external component interface 298 enables the computing environment 282 to communicate with various external components, such as external storage devices, input devices, speakers, modems, media player docks, other computing devices, scanners, digital cameras, and fingerprint readers.

Although illustrated as being components of a single computing environment 282, the components of the computing environment 282 can be spread across multiple computing environments 282. For example, one or more of instructions or data stored on the memory 284 may be stored partially or entirely in a separate computing environment 282 that is accessed over a network.

While particular uses of the technology have been illustrated and discussed above, the disclosed technology can be used with a variety of data structures and processes in accordance with many examples of the technology. The above discussion is not meant to suggest that the disclosed technology is only suitable for implementation with the components and operations shown and described above.

This disclosure described some aspects of the present technology with reference to the accompanying drawings, in which only some of the possible aspects were shown. Other aspects can, however, be embodied in different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method for managing a plurality of voice assistants, the method comprising:
determining a first order of the plurality of voice assistants;
based at least in part on the first order, activating one or more voice assistants of the plurality of voice assistants;
determining a second order of the plurality of voice assistants;
based at least in part on the second order, performing one or more of:
suspending an active voice assistant of the one or more active voice assistants; or
activating a suspended voice assistant of the plurality of voice assistants.

2. The method of claim 1, further comprising, prior to activating the one or more voice assistants of the plurality of voice assistants, determining a maximum number of active voice assistants;
wherein a number of the one or more active voice assistants is less than or equal to the maximum number of active voice assistants.

3. The method of claim 2, wherein the maximum number of active voice assistants is determined based at least in part on one or more of an available memory of a computing device, a battery life of the computing device, or a processing power of the computing device.

4. The method of claim 1, further comprising:
monitoring a computer resource; and
detecting a change in the computer resource;
wherein determining the second order of the plurality of voice assistants is performed in response to detecting the change in the computer resource.

5. The method of claim 1, wherein determining the second order of the plurality of voice assistants is performed in response to an event, wherein the event is not related to a user input.

6. The method of claim 1, further comprising:
determining whether a called voice assistant of the plurality of voice assistants is active;
in response to determining that the called voice assistant is not active, suspending, based at least in part on the first order, a selected voice assistant of the one or more active voice assistants;
activating the called voice assistant; and
in response to determining that the called voice assistant completed a task, determining the second order of the plurality of voice assistants.

7. The method of claim 1, further comprising:
determining whether a called voice assistant of the plurality of voice assistants is active;
in response to determining that the called voice assistant is not active, suspending, based at least in part on the first order, a temporarily suspended voice assistant of the one or more active voice assistants;
activating the called voice assistant;
in response to determining that the called voice assistant completed a task, suspending the called voice assistant and activating the temporarily suspended voice assistant.

8. The method of claim 1, wherein each of the plurality of voice assistants is on a same computing device.

9. The method of claim 1, wherein the first order of the plurality of voice assistants is based at least in part on a user preference; and
wherein the second order of the plurality of voice assistants is based at least in part on an updated user preference.

10. The method of claim 1, wherein the first order of the plurality of voice assistants and the second order of the plurality of voice assistants is based on a popularity of each voice assistant of the plurality of voice assistants.

11. The method of claim 1, wherein the first order of the plurality of voice assistants and the second order of the plurality of voice assistants is based on a recent use for each voice assistant of the plurality of voice assistants.

12. The method of claim 1, wherein the first order of the plurality of voice assistants is based at least in part on a first time of day;
wherein the second order of the plurality of voice assistants is based at least in part on a second time of day; and
wherein determining the second order of the plurality of voice assistants is performed in response to detecting a change of time.

13. The method of claim 1, wherein the first order of the plurality of voice assistants is a random order of the plurality of voice assistants; and
wherein the second order of the plurality of voice assistants is a non-random order of the plurality of voice assistants.

14. The method of claim 1, wherein one or more of the first order of the plurality of voice assistants or the second order of the plurality of voice assistants is based at least in part on an order of voice assistant icons displayed on a device.

15. A device for processing voice input, the device comprising:
a plurality of voice assistants;
a processor; and
memory storing instructions that, when executed by the processor, cause the device to:
determine a first order of the plurality of voice assistants;
based at least in part on the first order, activate one or more voice assistants of the plurality of voice assistants;
determine a second order of the plurality of voice assistants;
based at least in part on the second order, perform one or more of:
suspend an active voice assistant of the one or more active voice assistants; or
activate a suspended voice assistant of the plurality of voice assistants.

16. The device of claim 15, wherein the instructions, when executed by the processor, further cause the device to, prior to activating the one or more voice assistants of the plurality of voice assistants, determine, based on one or more of an available memory or battery life, a maximum number of active voice assistants; and
wherein activating the one or more voice assistants of the plurality of voice assistants comprises activating less than or equal to the maximum number of active voice assistants.

17. The device of claim 15, wherein determining the second order of the plurality of voice assistants is performed in response to an event;
wherein the event is related to one or more of a change in computer resources or a change in time.

18. The device of claim 15, wherein the first order of the plurality of voice assistants and the second order of the plurality of voice assistants are based on a historical usage of each voice assistant of the plurality of voice assistants.

19. A method for managing a plurality of voice assistants, the method comprising:
determining a first order of the plurality of voice assistants;
based at least in part on the first order, grouping the plurality of voice assistants into an active group of voice assistants and a suspended group of voice assistants;
activating each voice assistant of the active group of voice assistants;
detecting an event;
in response to detecting the event, determining a second order of the plurality of voice assistants;
based at least in part on the second order, performing one or more of:
suspending a voice assistant of the active group of voice assistants; or
activating a voice assistant of the suspended group of voice assistants.

20. The method of claim 19, wherein one or more of the first order of the plurality of voice assistants or the second order of the plurality of voice assistants is based at least in part on a similarity of one or more voice assistants of the plurality of voice assistants.
